(19) United States
(12) Patent Application Publication
(10) Pub. No.: US 2021/0248586 A1
(43) Pub. Date: Aug. 12, 2021

(54) SYSTEM AND METHOD FOR PROCESSING PAYMENTS SECURELY

(71) Applicant: Evraam Gorgy, Onalaska, WI (US)

(72) Inventor: Evraam Gorgy, Onalaska, WI (US)

(21) Appl. No.: 16/783,197

(22) Filed: Feb. 6, 2020

(51) Int. Cl. G06Q 20/32; G06Q 20/02; G06Q 20/42; G06Q 20/10

(52) U.S. Cl. CPC G06Q 20/3255; G06Q 20/102; G06Q 20/42; G06Q 20/027

(57) ABSTRACT

The present invention processes mobile fund transfer or payments in lesser time utilizing Short Message Service (SMS) without involving third party fund transfer applications to be actively downloaded by the user on his or her smartphone, tablet, etc. The payor and the payee processes fund transfer in lesser time and securely and solely through mobile phone's SMS service.

### FIELD OF INVENTION

The present invention claims priority from the U.S. Provisional Patent Application No. 62/835,518 filed on Apr. 18, 2019.

This invention relates to a system and method for processing payments efficiently and securely over SMS (Short Message Service).

### DESCRIPTION OF PRIOR ART

Any discussion of documents, acts, materials, devices, articles or the like which has been included in this specification is solely for the purpose of providing a context for the present invention. It is not to be taken as an admission that any or all of these matters form a part of the prior art base or were common general knowledge in the field relevant to the present invention as it existed in the United States of America or elsewhere before the priority date of this application.

Fund transfer is an integral part of our day to day life. There are several fund transfer applications which work solely upon downloading third party applications including merchant application, bank and credit card applications etc. There are further applications like Mobile Wallet that stores credit cards, debit cards and rewards information on a mobile device. Likewise, there are several other applications that uses mobile technology of the smartphones and tablets for online transactions. Applications like Mobile Wallet uses near field communication (NFC) which uses radio frequencies to communicate between devices. Once the mobile wallet application is installed, the wallet stores the credit card, debit card and rewards information by linking a personal identification format for example a key, a QR Code or owner's image.

While the abovementioned methods of fund transfer are reliable but predominantly rely upon active internet connection. Moreover, the third-party software applications occupy a certain disk space and bandwidth of user's smartphone device. On the other hand, the present invention utilizes Short Message Service (SMS) to process mobile payments efficiently and instantly without the need of active internet connection at the user's end.

U.S. Pat. No. 8,662,384B2 to Dodin (2014) describes a computer-implemented method of effectuating an electronic on-line payment including receiving at a computer server system a text message from a payor containing a payment request representing a payment amount sent by a payor device operating independently of the computer server system, determining a payment amount associated with the text message and debiting a payor account for an amount corresponding to the amount of the payment request, and crediting an account of a payee that is independent of the computer server system. While Dodin describes a method of fund transfer by the payor device determining a payment amount associated with the text message but the process as mentioned above is effectuated through electronic online payment which actively needs internet connection while the present invention wherein the fund transfer request and the process of approval of fund transfer solely occurs through Short Message Service (SMS) sent to the payment platform and later on to the payee's device or phone. While there are many applications that initiate fund transfer but most of them either rely on payment reminders through SMS or verify their customers through SMS for multi factor authentication. No existing applications in the prior art relies solely on SMS platform in order to initiate, authenticate and approve fund transfer without relying on active internet connection or third party banking applications.

US Pat. App. No. US20080109281A1 to Csoka (2008) describes the method and system for transferring funds from a sending account to a payee. The sending account may be a pre-paid wireless telephone account. The method and system involve a transaction management system, an account setup module, a funds transfer module and a reporting module while Csoka justify the said system and manner of operation of fund transfer but necessarily requires a primary account or phone number associated with a pre-paid wireless telephone. In Csoka's, the communication of the payor with the transaction management system can either be via the IVR service (Interactive Voice Response) of the wireless phone service provider or over a communication network which may be a wireless network, internet, banking network, private communication network, virtual private network, proprietary communication network or the likes. However, the present invention solely relies on SMS (Short Message Service) to process fund transfer quickly from payor to payee without active involvement of internet or wireless network or third party banking applications. The present invention offers a quicker and convenient way to approve fund transfer using SMS service from plurality of service providers irrespective of whether the user's phone number is associated with a certain pre-paid wireless service provider.

### SUMMARY OF THE INVENTION

It is an object of the present invention to overcome, or substantially ameliorate, one or more of the disadvantages of the prior art, or to provide an efficient alternative.

It is yet another object of the present invention to process mobile fund transfer or payments in lesser time utilizing Short Message Service (SMS) without involving third party fund transfer applications to be actively downloaded by the user on his or her smartphone, tablet, etc.

It is yet another object of present invention to utilize Short Message Service (SMS) to approve fund transfer without the need of active internet connection or third party fund transfer applications. The payor and the payee process fund transfer in lesser time and securely and solely through mobile phone's SMS service.

It is yet another object of present invention wherein the system urges the payor to use PIN, fingerprint, or face ID to send or receive SMS in order to approve fund transfer to the payee. The payee may be an individual or a merchant who may use the present invention to securely and efficiently process payments and frequently reward customers and offer promotions, similarly various embodiments of the present system and method may be possible within the realms of present invention without limiting the scope of present invention.

It is yet another object of the present invention to develop a system and method to transfer funds solely through Short Message Service (SMS) of the mobile carrier without actively involving the internet connectivity at any stage of the fund transfer either at the payor's or payee's end.

The features and advantages of the present invention will become further apparent from the following detailed description of preferred embodiments, provided by way of example only, together with the accompanying drawings.

### BRIEF DESCRIPTION OF DRAWINGS

FIG. 1 illustrates a diagram for transfer of funds through SMS according to an embodiment of the present invention.

FIG. 2 illustrates a block diagram for transaction of funds according to an embodiment of the present invention.

FIG. 3 illustrates a flowchart depicting the process of fund transfer through SMS according to an embodiment of the present invention.

FIG. 4 illustrates yet another block diagram of the transaction process according to an embodiment of the present invention.

### DETAILED DESCRIPTION OF PREFERRED EMBODIMENTS

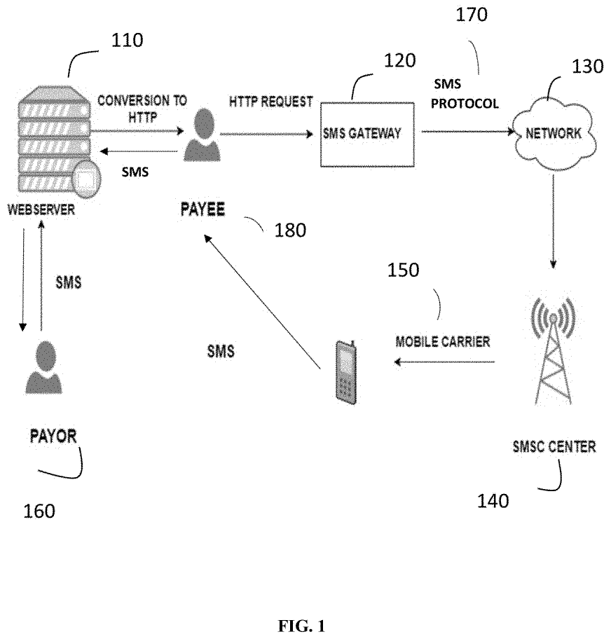

FIG. 1 illustrates a diagram for transfer of funds through SMS (Short Message Service). Payor 160 sends SMS to the webserver 110 of the present invention. The webserver 110 makes an entry of the received SMS for e.g. time of message, user details, payee's number etc. before sending the message to the network. Received SMS is further converted into HTTP (Hyper Text Transfer Protocol) before notifying payee of transaction initiation. Meanwhile, the payee 180 sends the reply to the webserver 110 with the requested invoice or bill amount. HTTP is further converted to SMS and sent to the payor 160. This protocol conversion is necessary because the request coming from webserver 110 is generally in the form of HTTP (Hyper Text Transfer Protocol) which effectively cross links and navigate various nodes of the webspace. The SMS gateway 120 acts as a bridge between SMS and HTTP network formats. Furthermore, SMS gateway communicates with SMS Centre (SMSC) 140 through SMS protocol 170 over network 130. Most of these SMS protocols or SMSC protocols are proprietary to the phone carrier 150 or service provider. The SMS Centre 140 stores the messages sent by the payor 160 and delivers to the intended payee 170.

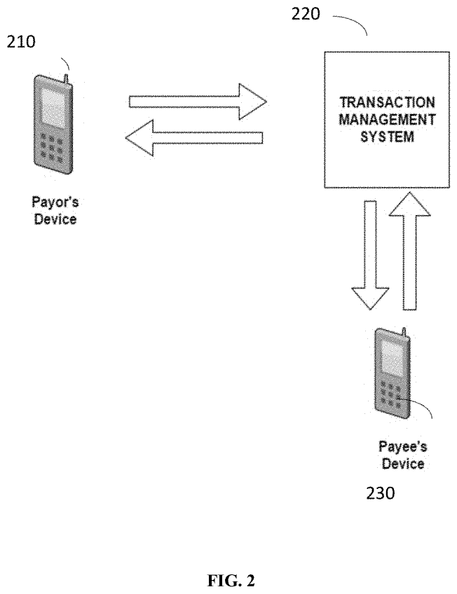

FIG. 2 illustrates a block diagram 200 for transaction of funds according to an embodiment of the present invention. Payor's device or phone 210 communicates with the transaction management system 220 of the present invention by the way of SMS (Short Service Message). Similarly, the payee's device or phone 230 interacts with the transaction management system 220 of the present invention by the way of SMS (Short Service Message). The process will become clearer by the way of embodiments described below.

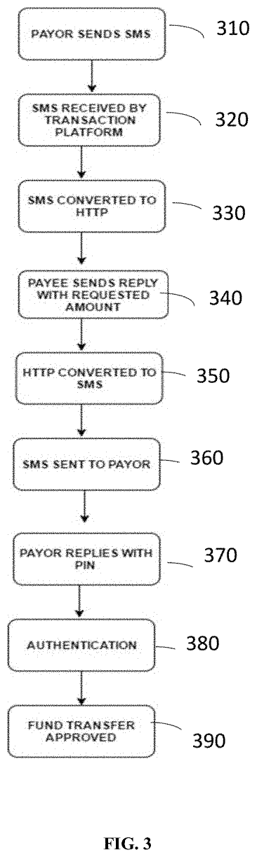

FIG. 3 illustrates a flowchart representation 300 of the actual flow of steps constituting the workflow. At step 310 the payor sends SMS to the transaction management system of the present invention. The payor's SMS is then received by the Transaction management system of the present invention at step 320. The received SMS is then converted to HTTP (Hyper Text Transfer Protocol) at step 330. This protocol conversion is necessary because the request coming from webserver is generally in the form of HTTP (Hyper Text Transfer Protocol) which effectively cross links and navigate various nodes of the webspace. At step 340, the payee sends reply with the requested amount in HTTP format to the transaction management system of the present invention. At step 350, the HTTP request is further converted to SMS by the transaction management system of the present invention before sending approval SMS to the payor. At step 360, SMS request with fund transfer approval is sent to the payor by the transaction management system. Upon receiving the SMS request, the payor replies with their security PIN (which the payor obtained during initial registration with the Transaction management system of the present invention) or other forms of approvals like fingerprint and Face ID (set by the payor during initial registration with the Transaction management system) for the approval of fund transfer. At step 380, the transaction ID, PIN or fingerprint or Face ID and Phone numbers of the payor is authenticated by the transaction management system. At step 390, the fund transfer is approved.

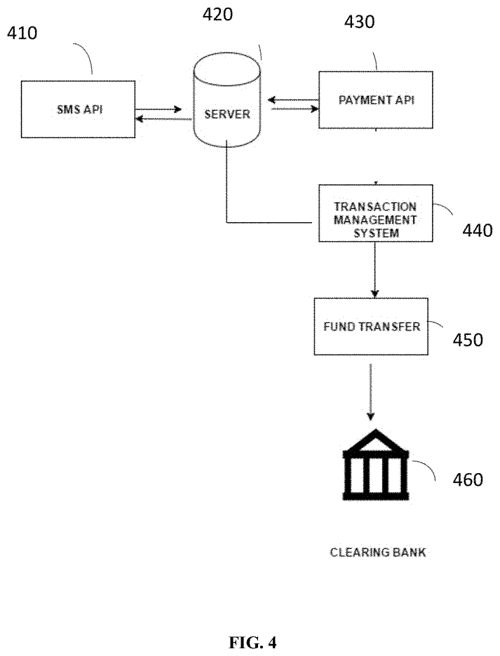

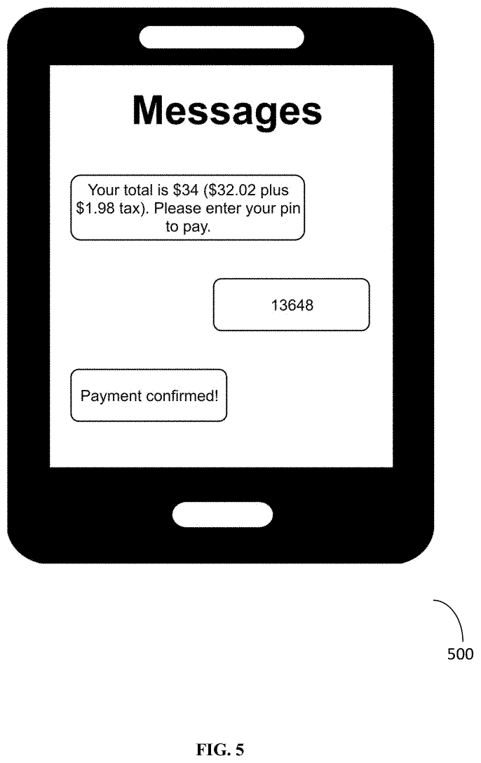

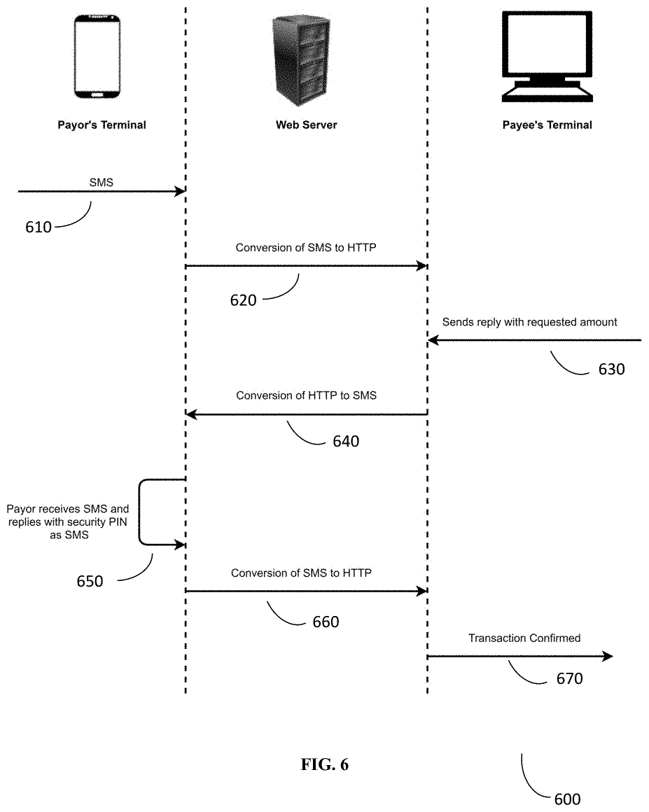

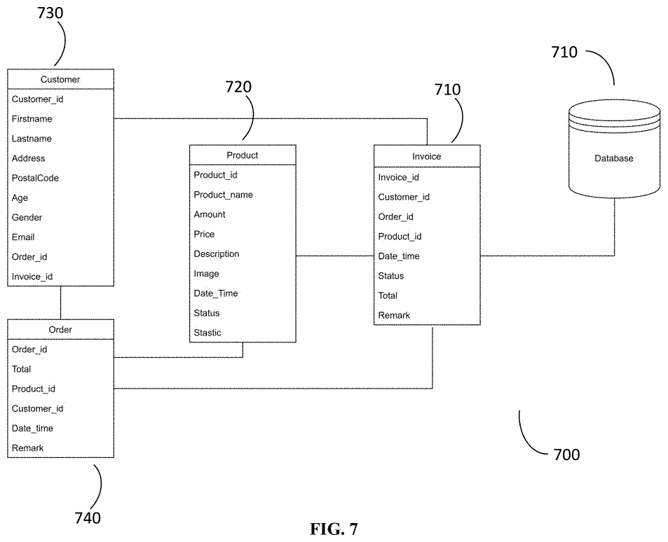

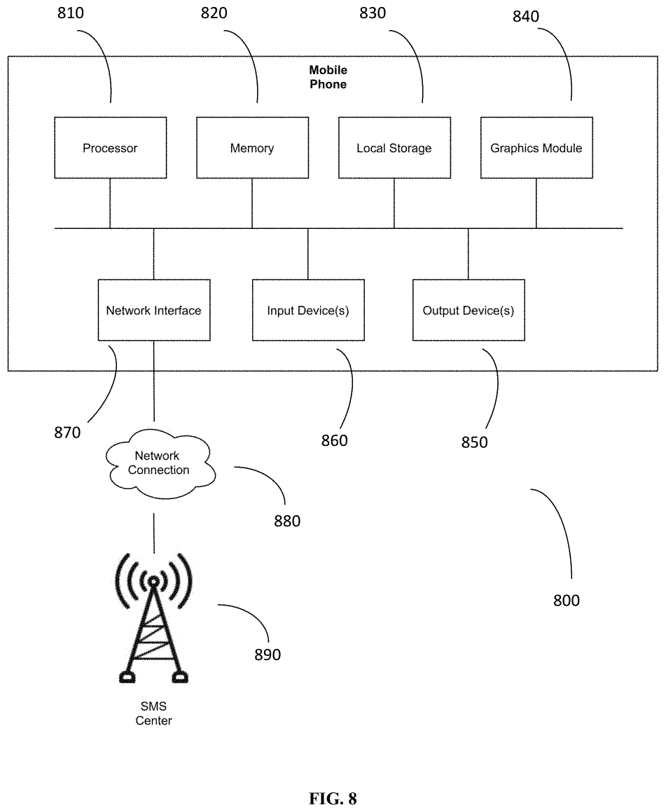

FIG. 4 illustrates yet another block diagram of the transaction process according to an embodiment of the present invention. At step 410, the SMS API (Application Programming Interface) communicates with the webserver 420 of the present invention. The server further interacts with the transaction management system 440 to facilitate fund transfer process to the payee. The payment API 430 communicates with the webserver 420 to facilitate fund transfer. At step 450, the transaction management system approves fund transfer to the payee. The funds thus transferred from the payor reaches the payee by the clearing bank 460.

FIG. 5 illustrates an exemplary diagram describing the process of fund transfer from payor's account to payee's account through SMS using a predefined security pin set by payor. Consider an embodiment screenshot 500 of the graphical user interface of the present invention, the payor receives the bill or invoice via SMS and replies with their security PIN to complete the transaction.

FIG. 6 illustrates an exemplary embodiment of the system 600 depicting the process of fund transfer from the payor's terminal to the payee's terminal through SMS using the cellular network. SMS sent by payor at step 610 gets converted into HTTP at step 620 in order to notify payee's transaction initiation. Payee then replies to the webserver at step 630 with the desired amount. At step 640, the received HTTP is then again converted by the webserver to SMS and sent to the payor. Upon receiving the SMS request, the payor replies with their security PIN at step 650 (which the payor obtained during initial registration with the Transaction management system of the present invention) for the approval of fund transfer. At step 660, SMS sent by payor is converted to HTTP. At step 670, the transaction ID, PIN and Phone numbers of the payor and payee are authenticated by the transaction management system of the present invention and the fund transfer is approved.

FIG. 7 illustrates an exemplary flowchart representation 700 of the database 750 of the system containing data of the customer (payor), product, order and invoice. The system uses invoice table 710 along with customer table 730, product table 720 and order table 740 for generation of the invoice and transaction authentication.

FIG. 8 illustrates an exemplary embodiment of the system 800 for implementing the present invention. System 800 includes computing system which in turn comprises a processor 810 and a memory 820. Processor 810 is configured to execute program instructions—and maybe a real processor or a virtual processor. It will be understood that the computing system 800 does not suggest any limitation as to the scope of use or functionality of described embodiments. The computing system 800 may include but is not be limited to one or more of the general-purpose computer, a programmed microprocessor, a microcontroller, an integrated circuit, and other devices or arrangements of devices that are capable of implementing the steps that constitute the method of the present invention. Exemplary embodiments of a computing system 800 in accordance with the present invention may include one or more servers, desktops, laptops, tablets, smartphones, mobile phones, mobile communication devices, tablets, phablets, and personal digital assistants. In an embodiment of the present invention, the memory 820 may store instructions for implementing various embodiments of the present invention. The local storage 830 may include any types of computer memory, magnetic stripes, smart cards, printed barcodes or any other transitory or non-transitory medium which may be used to store information and can be accessed by the computing system. The input device(s) 860 may include, but is not limited to, a touch screen, a keyboard, mouse, pen, joystick, trackball, a voice device, a scanning device, or any other device that can provide input to the computing system. In an embodiment of the present invention, the input device(s) 860 may be a sound card or similar device that accepts audio input in analog or digital form. The output device(s) 850 may include, but not be limited to a user interface on CRT, LCD, LED display, or any other display associated with any of servers, desktops, laptops, tablets, smartphones, mobile phones, mobile communication devices, tablets, phablets and personal digital assistants, printer, speaker, CD/DVD writer, or any other device that provides output from the computer system. In various embodiments of the present invention, the storage 830 may contain program instructions for implementing any of the above-described embodiments. In an embodiment of the present invention, the computer system is part of a distributed network or a part of a set of available cloud resources. The method described in the present invention comprises a set of program instructions that are executed by the computing system or any other similar device. The set of program instructions may be a series of computer-readable codes stored on a tangible medium, such as a computer-readable storage medium (storage 830). The graphic module 840 includes graphic card for displaying interactive content on the screen. In an embodiment of the present invention, the network interface may include an ethernet card or other network interface controller that connects the device to the network 880 which in turn is connected to the SMS center 890.

While a number of preferred embodiments have been described, it will be appreciated by persons skilled in the art that numerous variations and/or modifications may be made to the invention without departing from the spirit or scope of the invention as broadly described. The specification uses words “device” and “phone” interchangeably. The present embodiments are, therefore, to be considered in all respects as illustrative and not restrictive.

1. A transaction management system for facilitating transfer of funds from payor's account to payee's account comprising:
a payor's terminal;
a payee's terminal;
a web server;
a transaction management system;
an SMS (Short Message Service) gateway acting as a bridge between SMS and HTTP network formats converting SMS to HTTP format and vice versa;
an SMS center communicating with SMS gateway through carrier SMS protocol.

2. A method for transferring funds from payor's account to payee's account comprising the steps of:
a.) sending invoice or bill request via payor's terminal to the web server in SMS format;
b.) converting the invoice or bill request from SMS format to HTTP format;
c.) responding to the HTTP request at the payee's terminal by sending an HTTP message to the web server;
d.) converting said HTTP message into SMS format;
e.) receiving said SMS at the payor's terminal by the payor and responding with a security pin through SMS;
f.) authenticating transaction ID, PIN or fingerprint or Face ID and Phone numbers of the payor by the transaction management system.
g.) approving the fund transfer.

3. A method for transferring funds from payor's account to payee's account, according to claim 2 wherein, the SMS API (Application Programming Interface) communicates with the webserver of the present invention.

4. A method for transferring funds from payor's account to payee's account, according to claim 3 wherein, the server further interacts with the transaction management system to facilitate fund transfer process to the payee.

5. A method for transferring funds from payor's account to payee's account, according to claim 4 wherein, the payment API communicates with the web server to facilitate fund transfer.

6. A method for transferring funds from payor's account to payee's account, according to claim 5 wherein, the transaction management system approves fund transfer to the payee.

7. A method for transferring funds from payor's account to payee's account according to claim 6 wherein, the funds thus transferred from the payor reaches the payee by the clearing bank.

8. A method for transferring funds from payor's account to payee's account according to claim 2 wherein, the process of fund transfer from payor's account to payee's account through SMS using a predefined security pin set by payor.

9. A method for transferring funds from payor's account to payee's account according to claim 8 wherein, the payor receives the bill or invoice via SMS and replies with their security PIN to complete the transaction.

10. A transaction management system for facilitating transfer of funds from payor's account to payee's account according to claim 1, wherein the SMS Centre stores the messages sent by the payor and delivers to the intended payee.

11. A transaction management system for facilitating transfer of funds from payor's account to payee's account wherein, the system uses invoice table along with customer table, product table and order table for generation of the invoice and transaction authentication.

12. A transaction management system for facilitating transfer of funds from payor's account to payee's account according to claim 1, wherein the system urges the payor to use PIN, fingerprint, or face ID to send or receive SMS in order to approve fund transfer to the payee.

13. A transaction management system for facilitating transfer of funds from payor's account to payee's account according to claim 12, the payee may be an individual or a merchant who may use the present invention to securely and efficiently process payments and frequently reward customers and offer promotions.

14. A transaction management system for facilitating transfer of funds from payor's account to payee's account according to claim 12, wherein the system transfer funds solely through Short Message Service (SMS) of the mobile carrier without actively involving the internet connectivity at any stage of the fund transfer either at the payor's or payee's end.
